(19) United States
(12) Patent Application Publication
(10) Pub. No.: US 2018/0183609 A1
(43) Pub. Date: Jun. 28, 2018

(54) REMOTE ATTESTATION OF A NETWORK ENDPOINT DEVICE

(71) Applicant: Hewlett Packard Enterprise Development LP, Houston, TX (US)

(72) Inventors: Adrian Shaw, Bristol (GB); Ludovic Emmanuel Paul N. Jacquin, Bristol (GB); David Plaquin, Bristol (GB)

(21) Appl. No.: 15/579,904

(22) PCT Filed: Jun. 5, 2015
(86) PCT No.: PCT/US2015/034393

§ 371 Date: Dec. 5, 2017

(51) Int. Cl. H04L 9/32; G06F 21/62; H04L 29/06; G06F 21/60; H04L 9/14; H04L 9/08

(52) U.S. Cl. CPC H04L 9/3268; G06F 21/6218; H04L 63/0823; H04L 9/3271; H04L 9/14; H04L 9/083; G06F 21/602

(57) ABSTRACT

Examples relate to a network endpoint device of a first network infrastructure that facilitates remote attestation of the network endpoint device. In same examples, the network endpoint device comprises a trusted platform module and a processor that implements machine readable instructions that cause the network endpoint device to: receive a connection request from a computing device residing a second network infrastructure external to the first network infrastructure, the request comprising s security challenge; determine, based on a configuration of the network endpoint device, whether it can access information stored in the trusted platform module; and responsive to determining that information in the trusted platform module can be accessed, facilitate connection of the computing device to the network endpoint device by accessing the information and responding to the security challenge.

### BACKGROUND

Computing devices that connect to a network via a public hotspot or network endpoint device risk connecting to a gateway that may be susceptible to vulnerability or attack. An infrastructure provider may also be worried about having network endpoint devices infested with customized malware or with out of date firmware that may contain exploitable vulnerabilities. Determining risk associated with a network endpoint device to a network infrastructure can be technically challenging and inefficient

### BRIEF DESCRIPTION OF THE DRAWINGS

The following detailed description references the drawings, wherein:

FIG. 1 is a block diagram of an example system for remote attestation of a network endpoint device;

FIG. 2 is a block diagram of an example system for remote attestation of a network endpoint device;

FIG. 3 is a block diagram of an example system tor remote attestation of a network endpoint device;

FIG. 4 is a flowchart of an example method for facilitating remote attestation of a network endpoint device; and

FIG. 5 is a flowchart of an example method for facilitating remote attestation of a network endpoint device.

### DETAILED DESCRIPTION

The following detailed description refers to the accompanying drawings. Wherever possible, the same reference numbers are used in the drawings and the following description to refer to the same or similar parts. While several examples are described in this document, modifications, adaptations, and other implementations are possible. According the following detailed description does not limit the disclosed examples. Instead, the proper scope of the disclosed examples may be defined by the appended claims.

Computing devices that connect to a network via a public hotspot or network endpoint device risk connecting to a gateway that may be susceptible to vulnerability or attack. An infrastructure provider may also be worried about having network endpoint devices infected with customized malware or with out of date firmware that may contain exploitable vulnerabilities. Determining risk associated with a network endpoint device to a network infrastructure can be technically challenging and inefficient.

For example, computing devices wishing to connect to a network often experience slow response time when attempting remote attestation to the network (e.g. gaining trust that the network is safe to connect). This can be unsuitable, especially for mobile terminals that may connect to numerous networks within a short amount of time.

This technical challenge can be addressed by a novel technical solution that offers numerous advantages. The new technical solution involves having the connecting device challenge an access point (e.g., a network endpoint device) to have the network endpoint device provide that it is safe for connection. By having the network endpoint device prove integrity, numerous efficiencies may be obtained. Further, the connecting computing device may have less strain on it to connect to a network.

For example, a network endpoint device of a first network infrastructure may facilitate remote attestation of the network endpoint device to a client device residing on a second network infrastructure external to the first network infrastructure. The network endpoint device may include a trusted: platform module and a physical processor that implements machine readable instructions stored on a non-transitory machine-readable storage medium that cause the network endpoint device to perform functionality. The functionality may include, for example, receiving a connection request from the client device, the request comprising a security challenge; determining, based on a configuration of the network endpoint device, whether it can access information stored in the trusted platform module; and responsive to determining that information in the trusted platform module can be accessed, facilitating connection of the computing device to the network endpoint device by accessing the information and responding to the security challenge.

A TPM may comprise, for example, a hardware component comprising a cryptographic processor. The TPM may facilitate secure generation of cryptographic keys and their use. For example, the TPM may allow one or more of remote attestation, binding, sealing, and/or other security functionality for the network endpoint device, and/or other communicably coupled components. Remote attestation may allow a third party to verify that the software of a hardware component has not been changed. Binding may encrypt data using a cryptographic key of the TPM. Sealing may encrypt data and specify a state in which the TPM must reside in order for the data to be decrypted.

The TPM may store encrypted credentials for the network endpoint device, whereby the credentials may be used by a platform (e.g., an enterprise system comprising the network endpoint device, infrastructure credentialing authority, verifier credentialing authority, and/or other system component) to verify the identity of network endpoint device, verify software being executed on the network endpoint device, and/or provide other verification related to the network endpoint device. For example, the credentials stored in the TPM may be used to verify that a network endpoint device does not contain malicious software or software that has been tampered with. By making this verification, for example, a computing device that wants to connect to the network via the network endpoint device may be protected against attacks by a malicious party that may have already affected the network endpoint device.

As mentioned above, attempting to make such a verification, however, may pose significant technical challenges. An example network that addresses these technical challenges may comprise multiple credentialing authorities that interact with each network endpoint device.

An infrastructure credentialing authority (“ICA”) may be a credential authority of the network infrastructure. The ICA may know information related to each hardware component (e.g., each network endpoint device, credentialing authority, and/or other hardware component of the network) that is set up during creation of the network. For example, the ICA may know information about the identity of each network endpoint device, the software that is supposed to run on each network endpoint device, measurements associated with a software configuration of an endpoint device, and an endorsement key (“EK”) pair stored in a trusted platform module of each network device. A network endpoint device may be deployed with a trusted platform module (“TPM”) that may have stored therein an endorsement key pair for the network endpoint device. The endorsement key pair may be permanently stored in the TPM of the network endpoint device for the lifetime of the device.

Given that the endorsement key pair is permanent the ICA may also create pseudo-identities for each network element, as a precautionary security measure to protect the endorsement key pair. The ICA may create an attestation identity key (“AIK”) that is derived from the EK for a network endpoint device, where the AIK acts as the pseudo-identity for the network endpoint device. As such, even if the AIK is compromised, the endorsement key pair stored in the trusted platform may not be compromised. Further, by deriving the AIK from the EK stored in the TPM of a network endpoint device, it may be proved that the AIK is associated with a network endpoint device without having to reveal the endorsement key pair.

The ICA may also know the correct software configuration for a network endpoint device. Consequently, if the data in the TPM is sealed using information about the software configuration, the ICA may be able to determine whether the data in the TPM should be made available.

A verifier credentialing authority (“VCA”) may act as a second credentialing authority in the network and may communicate with the ICA and with each network endpoint device. The VCA may be an independent hardware entity in the network that computing devices in the network may rely on to vouch for the integrity of a network endpoint device. By having a deliberate, logical separation between the ICA and the VCA, a computing device (and user) may not have to put all of their trust in one party, making remote attestation of a network endpoint device more robust.

In order to provide robust remote attestation, the VCA may need to be bootstrapped (e.g., initialized). The VCA may receive information from the ICA about each NED in the network. For example, the VCA may receive information about the identity, software, software configuration measurements, and/or other characteristics of each network identify from the ICA. In some examples, the VCA may receive information about the software on each network endpoint device and may determine software configuration measurements for the network endpoint device. The VCA may store the information about each network endpoint device. In some examples, the VCA may challenge each network endpoint device to attest their software state (e.g., their current software configuration). The VCA may receive, from each network endpoint device, information about their software configuration. In some examples, the information about a software configuration may comprise a measurement value related to the software configuration, a cryptographic hash value of the measurement, and/or other information about the software configuration. The VCA may check the received information against the stored information about the network endpoint device to determine its integrity.

In order to facilitate remote attestation, the VCA may provision a certificate for each network endpoint device. A computing device that wants to connect to the network via the network endpoint device may access the VCA certificate and use the certificate to verify the integrity of the network endpoint device. For example, the computing device may present a challenge (e.g., a request for a signature, and/or other encryption challenge) to the network endpoint device. The computing device may then test the response of the network endpoint device by using a public key in the certificate to verify the integrity of the network endpoint device. For example, the computing device may use the public key of the certificate to encrypt data and send that data as a challenge to the network endpoint device. Responsive to the network endpoint device returning the decrypted data, the computing device may verify the integrity of the network endpoint device. In another example, the computing device may request that the network endpoint device respond with a digital signature and may verify the integrity of the network endpoint device based on the received response. In another example, the computing device may determine that the network endpoint device is not to be used responsive to not receiving a response to its challenge or responsive to receiving an erroneous response.

In order to provision the certificate, the VCA may facilitate various methods of key generation and distribution. For example, the VCA may use a migratable key scheme, a non-migratable key scheme, and/or other key schemes to facilitate remote attestation.

In a non-migratable scheme, each network endpoint device may autonomously create its own certificate key pair that may be certified by its AIK. The network endpoint device may send the certificate key pair (and/or a certificate with the certificate key pair) to the VCA and may request endorsement of the certificate key pair (and/or certificate). Responsive to the network endpoint device receiving a connection request from a computing device, the VCA may inspect the request to determine the integrity of the network endpoint device. For example, the request may comprise information related to she software configuration of the network endpoint device (and/or the network endpoint device may send information about its software configuration with the request). The VCA may determine whether the received software configuration information matches the stored values associated with the network endpoint device. Responsive to the information matching, the network endpoint device may respond to the computing device requesting connection with information proving its integrity.

In a migratable key scheme, the VCA may generate a global certificate key pair and send it to each network endpoint device to be stored in its TPM. As such, all network endpoint devices may comprise the same certificate key pair that may be sealed in their respective TPMs. The private key of tine certificate key pair may only be accessed if the software configuration of the network endpoint device matches the software configuration measurements used to seal the data in the TPM. As such, if the networks endpoint device is able to response to a challenge by a computing device with the private key or the certificate key pair, the network endpoint device has then verified that its software configuration has not been tampered with and that it has integrity.

Referring now to the drawings, FIG. 1 is a block diagram of an example system for facilitating remote attestation to a network endpoint device 100 by a computing device 200. The system may be run on a platform provided by a backend computing environment and made available to users associated with the backend computing environment. In some examples, the backend computing environment may comprise an enterprise system, an intranet, a cloud network, and/or other computing environment

The network endpoint device 100 may comprise components to facilitate connection and communication to components inside and outside of the network. In some examples, the network endpoint device 100 may comprise a processor 110, a non-transitory machine-readable storage medium 120, and a trusted platform (“TPM”) 130. Along with the processor 110 and storage medium 120, the TPM 130 of the network endpoint device 100 may have been deployed with the network endpoint device 100 on the network

The machine-readable storage medium of the network endpoint device 100 may comprise machine-readable instructions that may be executed by the network endpoint device 100 (e.g., by processor 110 and/or other component). A processor 110 of the network endpoint device 100 may comprise one or more central processing units (CPUs), microprocessor, and/or other hardware devices suitable for retrieval and execution of instructions stored in machine-readable storage medium of the network endpoint device 100. The processor 110 of the network endpoint device 100 may fetch, decode, and execute program instructions and/or other instructions to facilitate remote attestation so the network endpoint device 100, as described below. As an alternative or in addition to retrieving and executing instructions, a processor 110 of the network endpoint device 100 may include one or more electronic circuits comprising a number of electronic components for performing the functionality of one or more of instructions stored in a machine-readable storage medium 120 of the network endpoint device 100.

In one example, the machine-readable instructions implemented by the network endpoint device 100 can be part of an installation package that can be executed by a processor 110 of the network endpoint device 100 (and/or another component) to implement the functionality described herein. In another example, the machine-readable instructions may be part of an application or applications already installed on network endpoint device 100 or available to the network endpoint device 100 from a backend computing environment.

A machine-readable storage medium 120 of the network endpoint device 100 may be any hardware storage device tor maintaining data accessible to the network endpoint device 100. For example, machine-readable storage medium 120 may include one or more hard disk drives, solid state drives, tape drives, and/or any other storage devices. The storage devices may be located in network endpoint device 100 and/or in another device in communication with network endpoint device 100. For example, machine-readable storage medium 120 may be any electronic, magnetic, optical, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, and the like. As described in detail below, machine-readable storage medium 120 may be encoded with executable instructions for facilitating remote attestation of the network endpoint device 100. As detailed below, the storage medium 120 of the network endpoint device 100 may maintain and/or store the data and information described herein.

Trusted perform module (“TPM”) 130 may comprise, for example, a hardware component comprising a cryptographic processor. The TPM 130 may adhere to a recognized industry standard. For example, the TPM 130 may comply with an international standard written by the Trusted Computing Group. The TPM 130 may comply with standard 1.2, with upcoming standard 2.0, and/or other agreed-upon industry standards.

The TPM 130 may facilitate secure generation of cryptographic keys and their use. For example, the TPM 130 may perform one or more of remote attestation, binding, sealing, and/or other security functionality for the network endpoint device, and/or other communicably coupled components.

The TPM 130 may store encrypted credentials for the network endpoint device 190, whereby the credentials may be used by a platform (e.g., an enterprise system comprising the network endpoint device 100, infrastructure credentialing authority, verifier credentialing authority, and/or other system component) to verify the identity of the network endpoint device 100, verify software being executed on the network endpoint device 100, and/or provide other verification related to the network endpoint device 100. The credentials stored in the TPM 130 may comprise an endorsement key pair, an attestation identity key, a certificate key pair, and/or other credentials.

The endorsement key pair may have been created and stored in the TPM 130 before deployment of the network endpoint device 100 in the network. The endorsement key pair may be stored in the TPM 130 for the lifetime of the network endpoint device 100 and may not be changed.

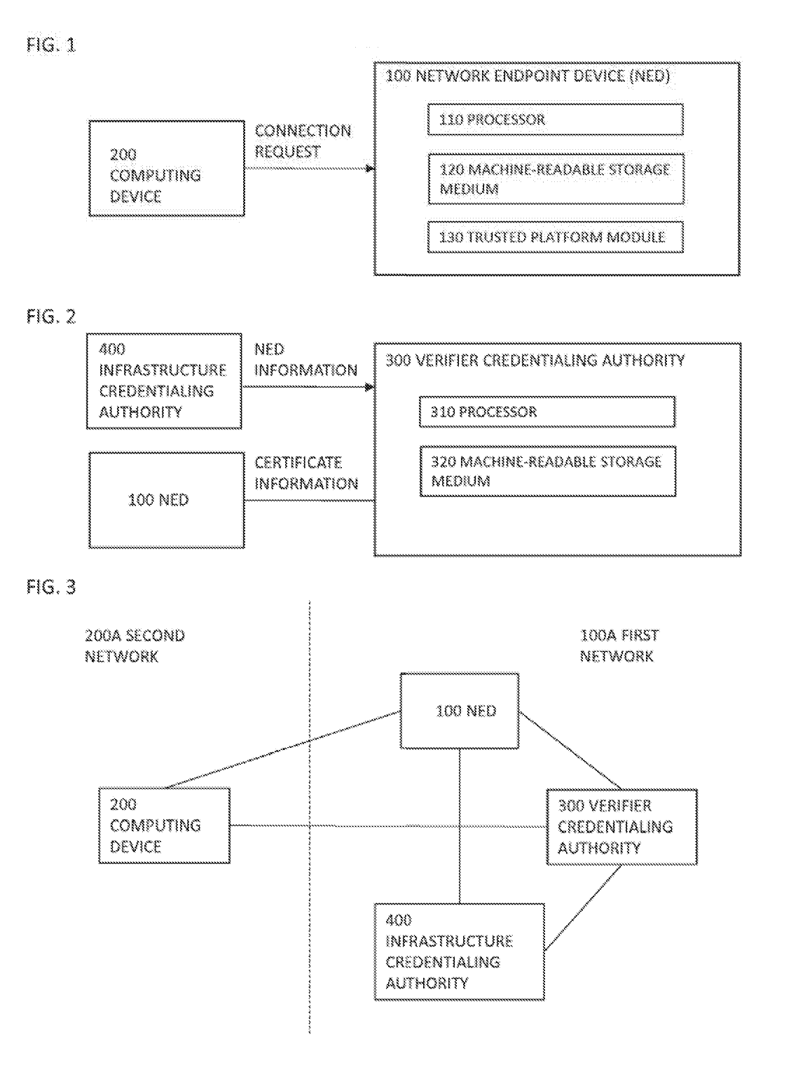

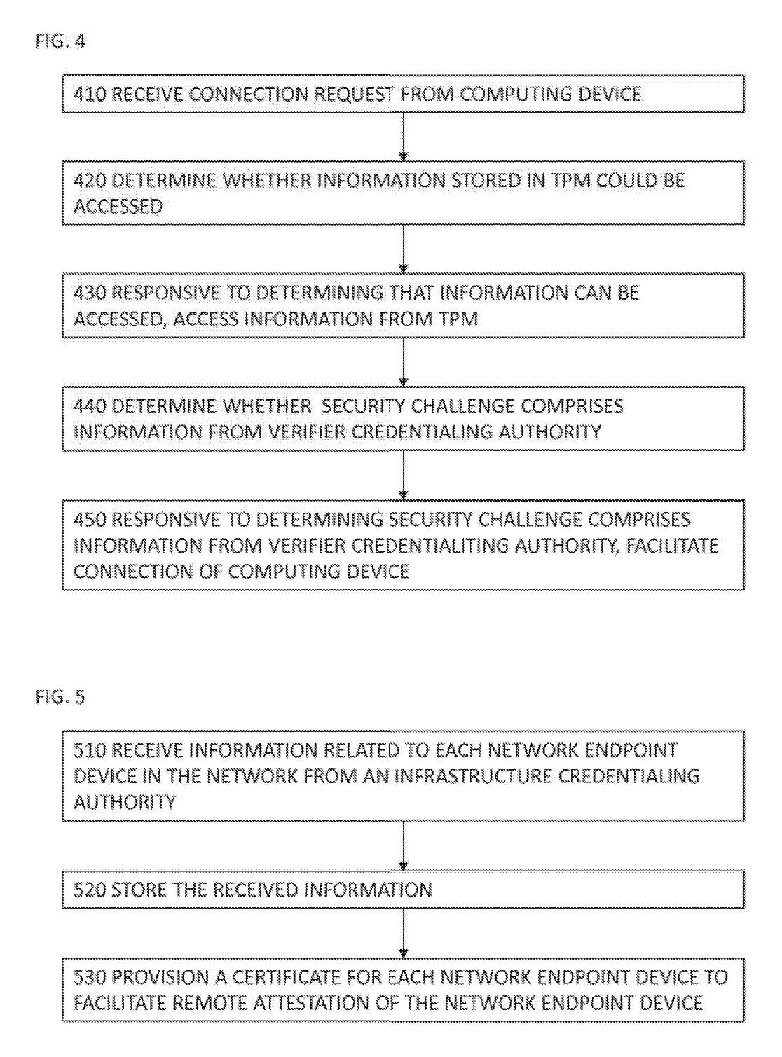

The attestation identity key (“AIK”) may be received from an infrastructure credentialing authority for the network (described in further detail with respect to FIGS. 2 and 3). The infrastructure credentialing authority may also be the infrastructure provider for the network, and may be aware of each of the hardware devices deployed on the network. As such, the infrastructure credentialing authority may have information related to each of the network endpoint devices, including information about identity, endorsement key pair, software configuration, and/or other information. The infrastructure credentialing authority may verify the identity of a network endpoint device based on its endorsement key pair. The infrastructure credentialing authority may derive, from an endorsement key pair, an attestation identity key for use by a network endpoint device and may send the derived attestation identity key to the respective network endpoint device. Because the endorsement key pair is permanent, the attestation identity key may be used instead as a precautionary security measure to protect the endorsement key pair.

The certificate key pair may be used during remote attestation of the network endpoint device 100. In some examples, the TPM 130 of the network endpoint device 100 may create a unique certificate key pair for the network endpoint device 100 and may seal the certificate key pair in the TPM 130. The network endpoint device 100 may also create a certificate based on the certificate key pair and may sign the certificate using the attestation identity key. The network endpoint device may then send the signed certificate to a verifier credentialing authority in the network to facilitate remote attestation. In another example, the network endpoint device 100 may receive a certificate key pair from the verifier credentialing authority and may seal the received certificate key pair in the TPM 130. The certificate key pair and its use will be described in further detail below.

The TPM 130 may seal the data stored in the TPM using PCR measurements. PCR measurements may be used by the TPM 130 to verify access to data stored in the TPM is legitimate. The PCR measurements may comprise measurements relating to a software configuration of the network endpoint device 100. The PCR measurements relating to a software configuration of the network endpoint device may have been determined at deployment of the network endpoint device 100 and may be known by the infrastructure credentialing authority as well.

The credentials stored in the TPM 130 may be used to facilitate remote attestation of the network endpoint device 100 (i.e., verify that a network endpoint device 100 does not contain malicious software or software that has been tampered with). By facilitating remote attestation, for example, a computing device 200 that wants to connect to the network via the network endpoint device 100 may be protected against attacks by a malicious party that may have already affected the network endpoint device 100.

To facilitate remote attestation, the network endpoint device 100 may receive a connection request from a computing device residing on a second network infrastructure external to the first network infrastructure, the request comprising a security challenge. The network endpoint device 100 may then determine, based on a configuration of the network endpoint device 100, whether it can access information stored in the trusted platforms module 130. For example, the network endpoint device 100 may need to use credentials stored in the TPM 130 to respond to the security challenge.

To determine whether it may access information stored in the TPM 130, the network endpoint device 130 may determine PCR measurements based on its software configuration. The TPM 130 may then compare the determined PCR measurements with the PCR measurements that have been used to seal the TPM 130. Responsive to the determined PCR measurements matching the PCR measurements of the TPM 130, the network endpoint device may determine that the credentials stored in the TPM 130 may be accessed.

Responsive to determining that the credentials stored in the TPM 130 may be accessed, the network endpoint device 130 may facilitate connection with the computing device that sent the connection request by accessing the credentials and responding to the security challenge. In some examples, the credentials used to respond to the security challenge may comprise the certificate key pair and/or the attestation identity key. For example, in a situation where the security challenge comprises a signature request, a certificate key of the certificate key pair and/or the attestation identity key may be used. In another example, in a situation where the security challenge comprises a nonce and an encrypted message, the private key of the certificate key pair may be used to decrypt the encrypted message to respond to the security challenge. More information about how the network endpoint device 100 responds to the security challenge will be provided below with respect to FIGS. 2 and 3.

In some examples in which the software configuration of the network endpoint device 100 is known to not change (e.g., to be permanent, at least unlit reboot of the platform), the network endpoint device 100 may store an encrypted version of attestation identity key in a memory outside of the TPM 130 (e.g., in a flash memory of the network endpoint device 130). This may allow for a faster response to the security challenge. In some examples, the attestation identify key may be encrypted by a certificate key of the certificate key pair, and the attestation identity key may only be encrypted responsive to accessing the certificate key pair via the TPM 130 in a manner similar to that described above.

In some examples in which the software configuration of the network endpoint device 100 may be changed (e.g., in which the software programs and modules loaded on the network endpoint device 100 may change), the network endpoint device 100 may store the attestation identity key in a memory outside of the TPM 130. Again, this may allow for a faster response to the security challenge. In some examples, the attestation identity key may be made available via an application programming interface of the TPM 130. The network endpoint device 130 may erase the attestation identity key from the memory responsive to determining that software in the network endpoint device 130 may be changed. By erasing the key prior to any change in software, the key may be kept safe from any malicious software that may be downloaded and/or run on the network endpoint device 100.

FIG. 2 is a block diagram of an example system for remote attestation of a network endpoint device. The system of FIG. 2 may be the same as or similar to the system of FIG. 1. For example, the system of FIG. 2 may be run on a platform provided by a backend computing environment and made available to users associated with the backend computing environment. In some examples, the backend computing environment may comprise an enterprise system, an intranet, a cloud network, and/or other computing environment. As shown in FIG. 2, the system may comprise a network endpoint device 100 that may be the same as or similar to network endpoint device 100 of FIG. 1. The system may also comprise an infrastructure credentialing authority 400 and a verifier credentialing authority 300. The infrastructure credentialing authority 400 may be the same as or similar to the infrastructure credentialing authority described above with respect to FIG. 1. Further, the infrastructure credentialing authority 400 may send the information it stores about each network endpoint device (e.g., information about identity, endorsement key pairs, attestation identity key, software configuration, and/or other information) to the verifier credentialing authority 300.

The verifier credentialing authority 300 may comprise components to facilitate connection and communication to components inside and outside of the network. In some examples, the verifier credentialing authority 300 may comprise a processor 310, a non-transitory machine-readable storage medium 320, and/or other components.

The machine-readable storage medium 320 of the verifier credentialing authority 300 may comprise machine-readable instructions that may be executed by the verifier credentialing authority 300 (e.g., by processor 310 and/or other component). A processor 310 of the verifier credentialing authority 300 may comprise one or more central processing units (CPUs), microprocessors, and/or other hardware devices suitable for retrieval and execution of instructions stored in machine-readable storage medium of the verifier credentialing authority 300. The processor 310 of the verifier credentialing authority 300 may fetch, decode, and execute program instructions and/or other instructions to facilitate remote attestation to the network endpoint device 100, as described below. As an alternative or in addition to retrieving and executing instructions, a processor 310 of the verifier credentialing authority 300 may include one or mere electronic circuits comprising a number of electronic components for performing the functionality of one or more of instructions stored in a machine-readable storage medium 320 of the verifier credentialing authority 300.

In one example, the machine-readable instructions implemented by the verifier credentialing authority 300 can be part of an installation package that can be executed by a processor 310 of the verifier credentialing authority 300 (and/or another component) to implement the functionality described herein. In another example, the machine-readable instructions may be part of an application or applications already installed on verifier credentialing authority 300 or available to the verifier credentialing authority 300 from a backend computing environment.

A machine-readable storage medium 320 of the verifier credentialing authority 300 may be any hardware storage device tor maintaining data accessible to the verifier credentialing authority 300. For example, machine-readable storage medium 320 may include one or more hard disk drives, solid state drives, tape drives, and/or any other storage devices. The storage devices may be located in verifier credentialing authority 300 and/or in another device in communication with verifier credentialing authority 300. For example, machine-readable storage medium 320 may be any electronic, magnetic, optical, or other physical storage device that stores executable instructions. Thus, machine-readable storage medium 320 may be, for example, Random Access Memory (RAM), an Electrically-Erasable Programmable Read-Only Memory (EEPROM), a storage drive, an optical disc, and the like. As described in detail below, machine-readable storage medium 320 may be encoded with executable instructions for facilitating remote attestation of the network endpoint device 100. As detailed below, the storage medium 320 of the verifier credentialing authority 300 may maintain and/or store the data and information described herein.

The verifier credentialing authority (“VCA”) 300 may act as a second credentialing authority in the network and may communicate with the infrastructure credentialing authority 400 and with each network endpoint device 100. The verifier credentialing authority 300 may be an independent hardware entity in the network that computing devices inside and outside of the network may rely on to vouch for the integrity of a network endpoint device 100. The verifier credentialing authority 300 may also be used to vouch for the integrity of other devices in the network (e.g., servers, and/or other hardware components). For example, the verifier credentialing authority 300 may be used to provide remote attestation for any device that uses an attestation identity key. By having a deliberate, logical separation between the infrastructure credentialing authority 400 and the verifier credentialing authority 300, a computing device (and user) may not have to put all of their trust in one party, making remote attestation of a device in the network more robust.

In order to provide robust remote attestation, the verifier credentialing authority 300 may need to be bootstrapped (e.g., initialized). As mentioned above, the verifier credentialing authority 300 may receive information from the infrastructure credentialing authority 400 about each network endpoint device 100 in the network. For example, the verifier credentialing authority 300 may receive information about the identity, software, software configuration measurements, and/or other characteristics of each network identity 100 from the infrastructure credentialing authority 400. In some examples, the verifier credentialing authority 300 may receive information about the software on each network endpoint device 100 and may determine software configuration measurements for the network endpoint device 100. The verifier credentialing authority 300 may store the information about each network endpoint device 100.

In some examples, the verifier credentialing authority 300 may challenge each network endpoint device 100 to attest their software state (e.g., their current software configuration). The verifier credentialing authority 300 may receive, from each network endpoint device 100, information about their software configuration. In some examples, the information about a software configuration may comprise a measurement value related to the software configuration, a cryptographic hash value of the measurement, and/or other information about the software configuration. The verifier credentialing authority 300 may check the received information against the stored information about the network endpoint device 100 to determine as integrity.

In order to facilitate remote attestation, the verifier credentialing authority 300 may provision a certificate for each network endpoint device 100. A computing device that wants to connect to the network via the network endpoint device 100 may access the certificate and use the certificate to verify the integrity of the network endpoint device 100. In some examples, the certificate may be made available for download via the Internet or via the network that the computing device wants to access. In some examples, the certificate may be pre-loaded on a SIM card used to access the desired network. The certificate may be accessed by a computing device in other manners as well and is not limited to the examples described herein.

In order to provision the certificate, the verifier credentialing authority 300 may facilitate various methods of key generation and distribution. For example, the verifier credentialing authority 300 may use a migratable key scheme, a non-migratable key scheme, and/or other key schemes to facilitate remote attestation.

In a non-migratable scheme, each network endpoint device 100 may autonomously create its own certificate key pair that may be certified by the attestation identity key of the network endpoint device 100. The network endpoint device 100 may send the certificate key pair (and/or a certificate with the certificate key pair) to the verifier credentialing authority 300 and may request endorsement of the certificate key pair (and/or certificate). Responsive to the network endpoint device 100 receiving a connection request from a computing device, the verifier credentialing authority 300 may inspect the request to determine the integrity of the network endpoint device 100. For example, the request may comprise information related to the software configuration of the network endpoint device 100 (and/or the network endpoint device 100 may send information about its software configuration with the request). The verifier credentialing authority 300 may determine whether the received software configuration information matches the stored values associated with the network endpoint device 100. Responsive to the information matching, the verifier credentialing authority 300 may send information to the network endpoint device indicating that the network endpoint device 100 may respond to the computing device requesting connection with information proving its integrity. In some examples, the verifier credentialing authority 300 may send the information proving integrity (e.g., a signed response, a decrypted message, etc.) to the network endpoint device 100. In some examples, the verifier credentialing authority 300 may send the information proving integrity (e.g., a signed response, a decrypted message, etc.) to the requesting computing device.

In a migratable key scheme, the verifier credentialing authority 300 may generate a global certificate key pair and may send the global certificate key pair to each network endpoint device to be stored in the trusted platform module of the network endpoint device. As such, all network endpoint devices may comprise the same certificate key pair that may be sealed in their respective trusted platform modules. For a network endpoint device 100, the private key of the certificate key pair may only be accessed by the network endpoint device 100 responsive to the software configuration of the network endpoint device 100 matching the software configuration measurements used to seal the data in the 130. As such, if the network endpoint device 100 is able to response to a challenge by a computing device using the private key of the certificate key pair, the network endpoint device 100 has then verified that its software configuration has not been tampered with and that it has integrity.

FIG. 3 is a block diagram of an example system tor remote attestation of a network endpoint device. The system of FIG. 2 may be the same as or similar to the system of FIGS. 1 and 2. For example, the system of FIG. 3 may be run on a platform provided by a backend computing environment and made available to users associated with the backend computing environment. In some examples, the backend computing environment may comprise an enterprise system, an intranet, a cloud network, and/or other computing environment. As shown in FIG. 3, the system may comprise a network endpoint device 100 that may be the same as or similar to network endpoint device 100 of FIG. 1. The system may also comprise an infrastructure credentialing authority 400 that may be the same as or similar to infrastructure credentialing authority 400 of FIG. 2 and a verifier credentialing authority 300 that may be the same as or similar to verifier credentialing authority 300 of FIG. 2 Further, the system may comprise a computing device 200 residing in a network 200a that requests connection to the network 100a comprising the infrastructure credentialing authority 400, the verifier credentialing authority 300, and the network endpoint device 100. The computing device 200 may request connection to the network via the network endpoint device 100

The computing device 200 may comprise components to facilitate connection and communication to components inside and outside of the network. In some examples, the computing device 200 may comprise a processor, a non-transitory machine-readable storage medium, and/or other components.

The machine-readable storage medium of the computing device 200 may comprise machine-readable instructions that may be executed by the computing device 200 (e.g., by processor and/or other component). A processor of the computing device 200 may comprise one or more central processing units (CPUs), microprocessors, and/or other hardware devices suitable for retrieval and execution of instructions stored in machine-readable storage medium of the computing device 200. The processor of the computing device 200 may fetch, decode, and execute program instructions and/or other instructions to facilitate remote attestation to the network endpoint device 100, as described below. As an alternative or in addition to retrieving and executing instructions, a processor of the computing device 200 may include one or more electronic circuits comprising a number of electronic components for performing the functionality of one or more of instructions stored in a machine-readable storage medium of the computing device 200.

In one example, the machine-readable instructions implemented by the computing device 200 can be part of an installation package that can be executed by a processor of the computing device 200 (and/or another component) to implement the functionality described herein. In another example, the machine-readable instructions may be part of an application or applications already installed on computing device 200 or available to the computing device 200 from a backend computing environment.

A machine-readable storage medium of the computing device 200 may be any hardware storage device for maintaining data accessible to the computing device 200. For example, machine-readable storage medium may include one or more hard disk drives, solid state drives, tape drives, and/or any other storage devices. The storage devices may be located in computing device 200 and/or in another device in communication with computing device 200. For example, machine-readable storage medium may be any electronic, magnetic, optical, or other physical storage device that stores executable instructions. Thus, machine-readable storage medium may be, for example, Random Access Memory (RAM), an Electrically-Erasable Programmable Read-Only Memory (EEPROM), a storage drive, an optical disc, and the like. As described in detail below, machine-readable storage medium may be encoded with executable instructions for facilitating remote attestation of the computing device 200. As detailed below, the storage medium of the computing device 200 may maintain and/or store the data and information described herein.

As described above, the computing device may request connection with the network 200a via the network endpoint device 100. The computing device 200 may obtain a certificate comprising a certificate key pair that facilitates remote attestation of the network endpoint device 100. In some examples, the certificate may be made available for download via the Internet or via the network 200a that the computing device 200 wants to access. In some examples, the certificate may be pre-loaded on a SIM card used to access the desired network 200a. The certificate may be accessed by computing device 200 in other manners as well and is not limited to the examples described herein.

After obtaining the certification, the computing device 200 may present a challenge (e.g., a request for a signature, and/or other encryption challenge) to the network endpoint device 100. The computing device 200 may then test the response of the network endpoint device 100 by using a public key in the certificate to verify the integrity of the network endpoint device 100. For example, the computing device 200 may use the public key of the certificate to encrypt data and send that data as a challenge to the network endpoint device 100. Responsive to the network endpoint device 100 returning the decrypted data, the computing device 200 may verify the integrity of the network endpoint device 100. In another example, the computing device 200 may request that the network endpoint device 100 respond with a digital signature and may verify the integrity of the network endpoint device 100 based on the received response. In another example, the computing device 200 may determine that the network endpoint device 100 is not to be used responsive to not receiving a response to its challenge within a predetermined time frame or responsive to receiving an erroneous response.

FIG. 4 is a flowchart of an example method for facilitating remote attestation so a network endpoint device. Although execution of the methods described below are with reference to system described in FIG. 1, other suitable devices for execution of this method will be apparent to those of skill in the art. The flowchart described in FIG. 4 and other figures may be implemented in the form of executable instructions stored on a machine-readable storage medium, such as the storage medium of the hypervisor, by one or more components described herein, and/or in the form of electronic circuitry.

In an operation 410, a network endpoint device may receive a connection request from a computing device residing on a network infrastructure different from the network infrastructure of the network endpoint device. In some examples, the system (and/or the network endpoint device 100) of FIG. 1 may receive the connection request. The network endpoint device (and/or other system components of FIG. 1) may receive the network connection request in a manner the same as or similar to that described above with respect to FIGS. 1-3.

In an operation 420, a determination may be made as to whether information stored in the trusted platform module of the network endpoint device may be accessed. The determination may be made based on a configuration of the network endpoint device. In some examples, the system (and/or the network endpoint device 100) of FIG. 1 may determine whether the information may be accessed. The network endpoint device (and/or other system components of FIG. 1) may determine whether the information may be accessed in a manner the same as or similar to that described above with respect to FIGS. 1-3.

In an operation 430, the information stored in the trusted platform module may be accessed responsive to determining that the information can be accessed. In some examples, the system (and/or the network endpoint device 100) of FIG. 1 may access the information. The network endpoint device (and/or other system components of FIG. 1) may access the information in a manner the same as or similar to that described above with respect to FIGS. 1-3.

In an operation 440, the network endpoint device may determine, based on the accessed information, whether the security challenge comprises information associated with a verifier credentialing authority residing on the first network infrastructure. In some examples, the system (and/or the network endpoint device 100) of FIG. 1 may determine whether the security challenge comprises information associated with a verifier credentialing authority residing on the first network infrastructure. The network endpoint device (and/or other system components of FIG. 1) may whether the security challenge comprises information associated with a verifier credentialing authority residing on the first network infrastructure in a manner the same as or similar to that described above with respect to FIGS. 1-3,.

In an operation 450, the network endpoint device may facilitate connection of the computing device to the network endpoint by responding to the security challenge. The network endpoint device may facilitate connection responsive to determining that the security challenge comprised information from the verifier credentialing authority. In some examples, the system (and/or the network endpoint device 100) of FIG. 1 may facilitate the connection. The network endpoint device (and/or other system components of FIG. 1) may facilitate the connection in a manner the same as or similar to that described above with respect to FIGS. 1-3.

FIG. 5 is a flowchart of an example method for facilitating remote attestation to a network endpoint device.

In an operation 510, a verifier credentialing authority may receive information related to each network endpoint device in a network from an infrastructure credentialing authority. In some examples, the system (and/or the verifier credentialing authority 300) of FIG. 2 may receive the information. The verifier credentialing authority (and/or other system components of FIG. 2) may receive the information in a manner the same as or similar to that described above with respect to FIGS. 1-3.

In an operation 520, the verifier credentialing authority may store the received information. In some examples, the system (and/or the verifier credentialing authority 300) of FIG. 2 may store the received information. The verifier credentialing authority (and/or other system components of FIG. 2) may store the received information in a manner the same as or similar to that described above with respect to FIGS. 1-3.

In an operation 530, the verifier credentialing authority may provision a certificate for each network endpoint device to facilitate remote attestation of the network endpoint device. In some examples, the system (and/or the verifier credentialing authority 300) of FIG. 2 may provision a certificate. The verifier credentialing authority (and/or other system components of FIG. 2) may provision a certificate in a manner the same as or similar to that described above with respect to FIGS. 1-3.

The foregoing disclosure describes a number of example embodiments for facilitating remote attestation to a network endpoint device. The disclosed examples may include systems, devices, computer-readable storage media, and methods for facilitating remote attestation to a network endpoint device. For purposes of explanation, certain examples am described with reference to the components illustrated in FIGS. 1-5. The functionality of the illustrated components may overlap, however, and may be present in a fewer or greater number of elements and components. Further, all or part of the functionality of illustrated elements may coexist or be distributed among several geographically dispersed locations. Moreover, the disclosed examples may be implemented in various environments and are not limited to the illustrated examples.

Further, the sequence of operations described in connection with FIGS. 1-5 are examples and are not intended to be limiting. Additional or fewer operations or combinations of operations may be used or may vary without departing fern the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within she scope of this disclosure and protected by the following claims.

1. A network endpoint device of a first network infrastructure that facilitates remote attestation of the network endpoint device, the network endpoint device comprising:
a trusted platform module;
a physical processor implementing machine readable instructions stored on a non-transitory machine-readable storage medium that cause the network endpoint device to:
receive a connection request from a computing device residing on a second network infrastructure external to the first network infrastructure, the request comprising a security challenge;
determine, based on a configuration of the network endpoint device, whether it can access information stored in the trusted platform module;
responsive to determining that information in the trusted platform module can be accessed, facilitate connection of the computing device to the network endpoint device by accessing the information and responding to the security challenge.

2. The network endpoint device of claim 1, wherein the physical processor implements machine readable instructions that cause the network endpoint device to determine whether information in the trusted platform module can be accessed by:
determining PCR measurements based on a software configuration of the network endpoint device;
comparing the determined PCR measurement with PCR measurements associated with the trusted platform module; and
responsive to the determined PCR measurements matching the associated PCR measurements, determining that the information stored in the trusted platform module can be accessed.

3. The network endpoint device of claim 2, wherein the physical processor implements machine readable instructions that cause the network endpoint device to:
receive an attestation identity key from an infrastructure credentialing authority; and
store the attestation identity key in the trusted platform module,
wherein the information stored in the trusted platform module comprises the attestation identity key, and wherein the attestation identity key is derived from an endorsement key pair stored in the trusted platform module.

4. The network endpoint device of claim 3, wherein the physical processor implements machine readable instructions that cause the network endpoint device to:
store an encrypted version of the attestation identity key in a memory of the network device;
decrypt the encrypted version of the attestation identity key responsive to determining that information in the trusted platform module can be accessed; and
respond to the security challenge by using the decrypted version of the attestation identity key.

5. The network endpoint device of claim 4, wherein the network endpoint device comprises a software configuration that may not be changed.

6. The network endpoint device of claim 3, wherein the network endpoint device comprises a set of software programs that may be changed, and wherein the physical processor implements machine readable instructions that cause the network endpoint device to:
store the attestation identity key in a memory;
make the attestation identity key available via an application programming interface of the trusted platform module; and
erase the attestation identity key from the memory responsive to a change in software of the network endpoint device.

7. The network endpoint device of claim 3, wherein the physical processor implements machine readable instructions that cause the network endpoint device to:
cause verification of the network endpoint device with an infrastructure credentialing authority of the first network infrastructure by using the endorsement key pair stored in the trusted platform module.

8. The network endpoint device of claim 3, wherein the physical processor implements machine readable instructions that cause the network endpoint device to:
create a unique certificate key pair;
seal the unique certificate key pair in the trusted platform module; and
create a certificate based on the unique certificate key pair;
sign the certificate using the attestation identity key;
send the signed certificate to a verifier credentialing authority, wherein the verifier credentialing authority resides on the first infrastructure network.

9. The network endpoint device of claim 3, wherein the physical processor implements machine readable instructions that cause the network endpoint device to:
receive a certificate key pair from a verifier credentialing authority, wherein the verifier credentialing authority resides on the first infrastructure network; and
seal the certificate key pair in the trusted platform module.

10. A method for facilitating remote attestation of a network endpoint device residing in a first network infrastructure, the network endpoint device comprising a physical processor implementing computer readable instructions and a trusted platform module, the method comprising:
receiving, by the processor, a connection request from a computing device residing on a second network infrastructure external to the first network infrastructure;
determining, by the processor, based on a configuration of the network endpoint device, whether information stored in the trusted platform module could be accessed;
responsive to determining that information in the trusted platform module can be accessed, accessing the information from the trusted platform module;
determining, based on the accessed information, whether the security challenge comprises information associated with a verifier credentialing authority residing on the first network infrastructure;
responsive to determining that the security challenge comprises information from the verifier credentialing authority, facilitating connection of the computing device to the network endpoint device by responding to the security challenge.

11. The method of claim 10, wherein the network endpoint device determines whether information in the trusted platform module can be accessed by:
determining PCR measurements based on a software configuration of the network endpoint device;
comparing the determined PCR measurements with PCR measurement associated with the trusted platform module; and
responsive to the determined PCR measurements matching the associated PCR measurements, determining that the information stored in the trusted platform module can be accessed.

12. The method of claim 11, further comprising:
receiving, by the processor, an attestation identity key from an infrastructure credentialing authority; and
storing, by the processor, the attestation identity key in the trusted platform module,
wherein the information stored in the trusted platform module comprises the attestation identity key, and wherein the attestation identity key is derived from an endorsement key pair stored in the trusted platform module.,

13. The method of claim 12, further comprising:
creating a unique certificate key pair;
sealing the unique certificate key pair in the trusted platform module; and
creating a certificate based on the unique certificate key pair;
signing the certificate using the attestation identity key;
sending the signed certificate to a verifier credentialing authority, wherein the verifier credentialing authority resides on the first infrastructure network, and
wherein the information from the verifier credentialing authority in the security challenge comprises information from the signed certificate.

14. The method of claim 12, wherein responding to the security challenge comprises:
using the certificate key pair to respond to the security challenge.

15. The method of claim 12, further comprising
receiving a certificate key pair from a verifier credentialing authority, wherein the verifier credentialing authority resides on the first infrastructure network; and sealing the certificate key pair in the trusted platform module.
